(19) United States
(12) Patent Application Publication
(10) Pub. No.: US 2025/0136262 A1
(43) Pub. Date: May 1, 2025

(54) SYSTEM AND METHOD FOR TREATING BOIL-OFF GAS OF SHIP

(71) Applicant: HANWHA OCEAN CO., LTD., Geoje-si, Gyeongsangnam-do (KR)

(72) Inventors: Zie Hyun KIM, Yongin-si, Gyeonggi-do (KR); Hye Min JUNG, Geoje-si, Gyeongsangnam-do (KR); Seung Chul LEE, Seoul (KR); Joon Chae LEE, Seoul (KR); Jin Ho CHOI, Incheon (KR)

(21) Appl. No.: 18/691,301

(22) PCT Filed: Dec. 24, 2021
(86) PCT No.: PCT/KR2021/019887

§ 371 Date: Mar. 12, 2024

(30) Foreign Application Priority Data
Sep. 15, 2021 (KR) 10-2021-0123382

(51) Int. Cl. B63J 4/00; B63B 17/00; B63H 21/38; F02M 25/08

(52) U.S. Cl. CPC B63J 4/00; B63B 17/0027; B63H 21/38; F02M 25/0836; F02M 25/0872

(57) ABSTRACT

A boil-off gas treatment system includes: a first compressor receiving boil-off gas generated from liquefied gas stored in a storage tank of a ship and compressing the boil-off gas; a second compressor compressing boil-off gas received from the storage tank; a heat exchanger cooling the boil-off gas compressed by the first compressor or the second compressor; and a refrigerant circulation line for circulating a refrigerant to the heat exchanger. The first compressor is a multistage compressor including a plurality of compressors and compressing the boil-off gas to a fuel supply pressure required for a propulsion engine. The second compressor compresses the boil-off gas to a fuel supply pressure required for a power generation engine which is lower than the propulsion engine. The boil-off gas compressed by part of the first compressor is supplied to the heat exchanger to be cooled or is supplied to the power generation engine.

### TECHNICAL FIELD

The present invention relates to a system and method for treating boil-off gas of a ship and, more particularly, to a system and method for treating boil-off gas of a ship including a propulsion engine and a power generation engine supplied with fuel at a lower pressure than the propulsion engine, in which boil-off gas (BOG) generated from liquefied gas stored in an onboard storage tank is supplied as fuel to the engines and boil-off gas remaining after fueling the engines is reliquefied and returned to the storage tank.

### BACKGROUND ART

Recently, consumption of liquefied gas such as liquefied natural gas (LNG) is rapidly increasing worldwide. Liquefied gas obtained by cooling a gas to a very low temperature has a much smaller volume than the gas and is thus beneficial in improving storage and transport efficiency. In addition, liquefied gas such as LNG emits little or no air pollutants during a liquefaction process and thus can be considered as an eco-friendly fuel with less emission of air pollutants during combustion.

LNG is a colorless and transparent liquid obtained by cooling natural gas containing methane as a main component to about −163° C., and has a volume of about 1/600 that of natural gas. Thus, liquefaction of natural gas allows efficient transportation of natural gas.

However, since natural gas is liquefied at a very low temperature of 162° C. under atmospheric pressure, LNG is sensitive to temperature change and evaporates easily. Although an LNG storage tank is insulated, LNG continues to evaporate naturally in the storage tank due to external heat continuously transferred to the storage tank during transportation, causing generation of boil-off gas (BOG).

Boil-off gas is a kind of loss and is critical to transportation efficiency. In addition, if boil-off gas is accumulated in the storage tank, the internal pressure of the tank can excessively increase, at worst causing damage to the tank. Accordingly, various methods have been studied to handle boil-off gas generated in a storage tank. Recently, in order to handle boil-off gas, there have been proposed a method of reliquefying boil-off gas and returning the reliquefied boil-off gas to the storage tank, a method of using boil-off gas as an energy source for on-board fuel demand sites such as a marine engine, and the like.

Examples of the method of reliquefying boil-off gas include providing a refrigeration cycle using a separate refrigerant to reliquefy boil-off gas through heat exchange with the refrigerant, reliquefying boil-off gas using boil-off gas itself as a refrigerant without a separate refrigerant, and the like.

Examples of a marine engine capable of being fueled by natural gas include gas-fueled engines such as DFDE, X-DF, and ME-GI engines.

The DFDE engine uses an Otto cycle consisting of four strokes, in which natural gas at a relatively low pressure of about 5.5 barg is injected into a combustion air inlet and then compressed by a piston moving upward.

The X-DF engine uses an Otto cycle consisting of two strokes, in which natural gas at a pressure of about 15 barg is used as fuel.

The ME-GI engine uses a diesel cycle consisting of two strokes, in which natural gas at a high pressure of about 300 barg is injected directly into a combustion chamber near the top dead point of a piston.

### DISCLOSURE

### Technical Tasks

The applicants of the present invention invented a method of reliquefying boil-off gas using the boil-off gas itself as a refrigerant without a separate refrigerant, wherein boil-off gas compressed by a compressor is cooled through heat exchange with uncompressed boil-off gas to be introduced into the compressor and is then expanded by a J-T valve or the like to achieve partial reliquefaction of boil-off gas. Such a system is referred to as a partial reliquefaction system (PRS).

When the amount of boil-off gas to be reliquefied is large, such as when the amount of liquefied gas in the storage tank is large and the amount of boil-off gas generated therefrom is thus large, or when a ship is at anchor or sails at low speed and the amount of boil-off gas consumed by an engine is thus low, the PRS alone cannot satisfy a required reliquefaction rate. Accordingly, the applicants of the present invention invented an improved PRS that can reliquefy much more boil-off gas.

As improvement of the PRS, a system capable of further cooling boil-off gas by a refrigerant cycle using the boil-off gas itself as a refrigerant is referred to as a methane refrigeration system (MRS).

A mixed refrigerant or a separate refrigerant such as nitrogen may be used to cool boil-off gas to be reliquefied.

For a ship equipped with an engine that can be fueled by boil-off gas, a compressor adapted to supply fuel to the engine may be used for reliquefaction of boil-off gas.

FIG. 1 is a schematic diagram of a boil-off gas treatment system for ships having engines E1, E2 fueled by boil-off gas generated from LNG, wherein boil-off gas compressed to a high pressure by compressors for fuel supply 10A, 10B is supplied as fuel to the engines and surplus compressed gas is cooled in a heat exchanger 20 using cold heat from boil-off gas, subjected to decompression 30 and gas-liquid separation 40, and returned to a storage tank.

Such a compressor 10A or 10B provided to supply fuel is designed to meet fuel supply requirements for a corresponding engine and is duplicated as classification societies require that an additional redundant compressor be provided in case of compressor failure. When fuel consumption of the engine is low and the amount of boil-off gas to be re-liquefied is large, such as when the ship is at anchor, the two compressors may both be operated. However, in this case, there are problems of low reliquefaction efficiency due to insufficient cold heat of the heat exchanger 20, low energy efficiency due to high electricity consumption for operation of both the high-pressure compressors, and high installation costs for the two high-pressure compressors.

In order to solve these problems, the present invention provides a solution capable of treating boil-off gas generated from liquefied gas while ensuring increase in reliquefaction efficiency and reduction in installation and operating costs.

### Technical Solution

In accordance with one aspect of the present invention, there is provided a boil-off gas treatment system of a ship, comprising: a first compressor receiving boil-off gas generated from liquefied gas stored in a storage tank of the ship and compressing the received boil-off gas;
a second compressor compressing boil-off gas received from the storage tank;
a heat exchanger cooling the boil-off gas compressed by the first compressor or the second compressor; and
a refrigerant circulation line along which a refrigerant supplied to the heat exchanger is circulated,
wherein the first compressor is a multistage compressor comprising a plurality of compressors and compressing the boil-off gas to a fuel supply pressure required for a propulsion engine of the ship, the second compressor compresses the boil-off gas to a fuel supply pressure required for a power generation engine supplied with fuel at a lower pressure than the propulsion engine, and
boil-off gas compressed while passing through part of the first compressor is supplied to the heat exchanger to be cooled or is supplied to the power generation engine.

The refrigerant circulation line may include: a refrigerant compression unit receiving the refrigerant discharged from the heat exchanger after heat exchange and compressing the received refrigerant; and a refrigerant expansion unit receiving the refrigerant compressed by the refrigerant compression unit and having passed through the heat exchanger, expanding and cooling the received refrigerant, and supplying the cooled refrigerant to the heat exchanger.

The boil-off gas treatment system may further include: a boil-off gas supply line along which boil-off gas is supplied from the storage tank to the first compressor or the second compressor through the heat exchanger; a first fuel supply line disposed downstream of the first compressor and connected to the propulsion engine; a reliquefaction line along which boil-off gas compressed while passing through part of the first compressor or through the second compressor is supplied to the heat exchanger to be cooled and is returned to the storage tank; and a second fuel supply line along which boil-off gas compressed while passing through part of the first compressor or through the second compressor is supplied to the power generation engine.

The boil-off gas treatment system may further include: a branch line branched off of the boil-off gas supply line and allowing boil-off gas to be supplied to the first compressor or the second compressor without passing through the heat exchanger; and a preheater provided to the branch line to heat the boil-off gas, wherein, when a reliquefaction system is not in operation or is operated at a low load, all or some of the boil-off gas generated in the storage tank may bypass the heat exchanger along the branch line to be heated by the preheater before being introduced into the first compressor or the second compressor.

The boil-off gas treatment system may further include: a decompressor receiving compressed boil-off gas cooled through heat exchange in the heat exchanger and decompressing the received compressed boil-off gas; and a gas-liquid separator receiving the boil-off gas decompressed by the decompressor and performing gas-liquid separation with respect to the received boil-off gas, wherein flash gas separated by the gas-liquid separator may be joined with a stream of uncompressed boil-off gas upstream of the heat exchanger, and liquefied gas separated by the gas-liquid separator may be returned to the storage tank.

The boil-off gas treatment system may further include: a liquefied gas supply line along which liquefied gas stored in the storage tank is supplied as fuel to the propulsion engine; a compression pump disposed on the liquefied gas supply line and pressurizing the liquefied gas to a fuel supply pressure required for the propulsion engine; and a vaporizer heating the liquefied gas pressurized by the compression pump.

The boil-off gas treatment system may further include: a liquefied gas branch line branched off of the liquefied gas supply line downstream of the vaporizer and connected to the power generation engine; a pressure regulating valve provided to the liquefied gas branch line and adjusting the liquefied gas to a fuel supply pressure required for the power generation engine; and a heater provided to the liquefied gas branch line and further heating the liquefied gas having passed through the pressure regulating valve to a fuel supply temperature required for the power generation engine.

When the ship is underway, the first compressor may be operated to compress boil-off gas generated in the storage tank and supply the compressed boil-off gas to the propulsion engine and the power generation engine and surplus compressed gas may be cooled by the heat exchanger, and, when the ship is at anchor, the second compressor may be operated to compress boil-off gas generated in the storage tank and to supply the compressed boil-off gas to the power generation engine and surplus compressed gas may be cooled by the heat exchanger.

The refrigerant circulated along the refrigerant circulation line may be nitrogen.

In accordance with another aspect of the present invention, there is provided a boil-off gas treatment method of a ship including a propulsion engine and a power generation engine supplied with fuel at a lower pressure than the propulsion engine,
wherein boil-off gas generated from liquefied gas stored in a storage tank is compressed by a first compressor or a second compressor, compressed gas not supplied as fuel to the propulsion engine and the power generation engine is cooled and reliquefied through heat exchange in a heat exchanger supplied with a refrigerant circulated along a refrigerant circulation line,
the first compressor is a multistage compressor comprising a plurality of compressors and compressing the boil-off gas to a fuel supply pressure required for the propulsion engine, the second compressor compresses the boil-off gas to a fuel supply pressure required for the power generation engine, and
boil-off gas compressed while passing through part of the first compressor is supplied to the heat exchanger to be cooled or is supplied to the power generation engine.

When the ship is underway, the first compressor may be operated to compress boil-off gas generated in the storage tank and supply the compressed boil-off gas to the propulsion engine and the power generation engine and surplus compressed gas may be cooled by the heat exchanger, and, when the ship is at anchor, the second compressor may be operated to compress boil-off gas generated in the storage tank and to supply the compressed boil-off gas to the power generation engine and surplus compressed gas may be cooled by the heat exchanger.

The refrigerant circulated along the refrigerant circulation line may be compressed by a refrigerant compression unit, cooled through the heat exchanger, expanded and cooled by a refrigerant expansion unit, and supplied to the heat exchanger as a cold heat source, wherein the refrigerant compression unit may be connected to the refrigerant expansion unit to compress the refrigerant using expansion energy of the refrigerant transmitted from the refrigerant expansion unit.

### Advantageous Effects

The present invention provides a boil-off gas treatment system for a ship including a propulsion engine and a power generation engine supplied with fuel at a lower pressure than the propulsion engine, wherein a first compressor compressing boil-off gas to a fuel supply pressure required for the propulsion engine and a second compressor compressing boil-off gas to a fuel supply pressure required for the power generation engine are provided and boil-off gas compressed while passing through part of the first compressor is supplied to a heat exchanger to be cooling or is supplied to the power generation engine.

As a multistage high-pressure compressor capable of supplying boil-off gas as fuel to a propulsion engine and a compressor capable of compressing boil-off gas to a pressure required for a power generation engine having a lower fuel supply pressure than the propulsion engine are provided to be selectively operated depending on the operation condition of a ship, consumption of electrical energy required for fuel supply and reliquefaction can be reduced through utilization of boil-off gas as fuel while meeting redundancy requirements, thereby ensuring efficient operation of the ship.

In addition, since the cooling efficiency and reliquefaction rate of the heat exchanger can be enhanced through utilization of cold heat from boil-off gas itself and cold heat from the refrigerant cycle and reliquefaction can be performed with respect to only boil-off gas remaining after boil-off gas generated in the storage tank is consumed as fuel, the load of the refrigerant cycle can be reduced while reducing consumption of liquefied gas as fuel.

### DESCRIPTION OF DRAWINGS

FIG. 1 is a schematic diagram of a conventional boil-off gas treatment system.

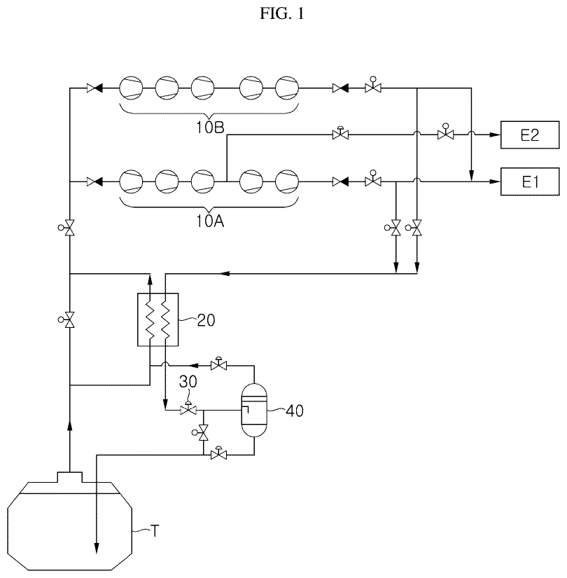

FIG. 2 is a schematic diagram of a boil-off gas treatment system according to a basic embodiment of the present invention.

FIG. 3 is a schematic diagram of a boil-off gas treatment system according to an expanded embodiment of the present invention.

### EMBODIMENTS

In order to fully appreciate the operational advantages of the present invention and the objectives achieved by practicing the present invention, reference should be made to the accompanying drawings, which illustrate preferred embodiments of the present invention, and description thereof.

Hereinafter, exemplary embodiments of the present invention will be described in detail in terms of the features and effects thereof with reference to the accompanying drawings. It should be noted that like components will be denoted by like reference numerals throughout the specification and the accompanying drawings.

As used herein, the term “ship” may refer to any type of ship that is provided with engines capable of utilizing liquefied gas and boil-off gas generated from the liquefied gas as fuel for propulsion or power generation or utilizes the liquefied gas or the boil-off gas as fuel for onboard engines. For example, the ship may include self-propelled vessels, such as an LNG carrier, a liquid hydrogen carrier, and an LNG regasification vessel (RV), as well as non-self-propelled floating offshore structures, such as an LNG floating production storage offloading (FPSO) unit and an LNG floating storage regasification unit (FSRU).

As used herein, the term “liquefied gas” may refer to any type of liquefied gas that can be transported in a liquid state by liquefaction at cryogenic temperatures, can generate boil-off gas during storage, and can be used as fuel for an engine and the like. For example, such liquefied gas may include liquefied petrochemical gas, such as liquefied natural gas (LNG), liquefied ethane gas (LEG), liquefied petroleum gas (LPG), liquefied ethylene gas, and liquefied propylene gas. In the following embodiments, the present invention will be described using LNG, which is a typical liquefied gas, as an example.

In the following embodiments, a fluid flowing through each line may be in a gaseous state, a gas-liquid mixed state, a liquid state, or a supercritical fluid state depending on system operating conditions.

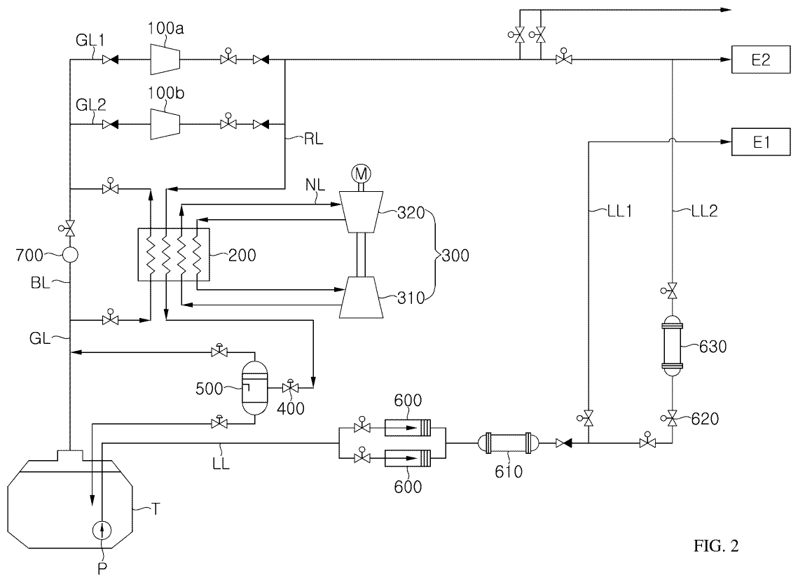

FIG. 2 is a schematic diagram of a boil-off gas treatment system for ships according to a basic embodiment of the present invention.

Referring to FIG. 2, the boil-off gas treatment system for ships according to this embodiment is provided to a ship to reliquefy boil-off gas generated in a liquefied gas storage tank, and includes: compressors 100a, 100b receiving boil-off gas generated in a storage tank T and compressing the received boil-off gas; and a heat exchanger 200 receiving all or some of the boil-off gas compressed by the compressors and cooling the received boil-off gas through heat exchange with a refrigerant and uncompressed boil-off gas to be introduced into the compressor. To this end, the boil-off gas treatment system includes: a gas supply line GL connected from the storage tank T to the compressors 100a, 100b through the heat exchanger; and a reliquefaction line RL disposed downstream of the compressor to reliquefy boil-off gas and deliver the reliquefied boil-off gas to the storage tank.

In addition, the boil-off gas treatment system includes a refrigerant circulation line NL along which the refrigerant supplied to the heat exchanger 200 is circulated, wherein the refrigerant circulation line NL is provided with a refrigerant expansion unit 310 expanding and cooling the refrigerant supplied to the heat exchanger and a refrigerant compression unit 320 compressing the refrigerant discharged from the heat exchanger after heat exchange.

In one embodiment, the refrigerant compression unit 320 and the refrigerant expansion unit 310 may be connected to each other via a common shaft to form a compander (compressor/expander) such that the refrigerant compression unit 320 can be driven by expansion energy of the refrigerant transmitted from the refrigerant expansion unit 310. In another embodiment, the refrigerant compression unit 320 may be driven by a motor connected to the refrigerant expansion unit 310, such that the refrigerant can be compressed as the motor is driven by expansion energy of the refrigerant transmitted from the refrigerant expansion unit 310.

The refrigerant compressed by the refrigerant compression unit 320 is introduced into the heat exchanger 200 to be cooled, is then supplied to the refrigerant expansion unit 310 along the refrigerant circulation line NL to be expanded and cooled, and is then supplied back to the heat exchanger 200 as a refrigerant.

Accordingly, in the heat exchanger 200 according to this embodiment, four different streams, that is, all or some of the compressed boil-off gas, the uncompressed boil-off gas to be introduced into the compressor, the refrigerant expanded and cooled by the refrigerant expansion unit, and the refrigerant compressed by the refrigerant compression unit, participate in heat exchange.

The refrigerant supplied to the heat exchanger while circulating along the refrigerant circulation line NL may be, for example, nitrogen N2. Cooling boil-off gas through heat exchange by a refrigerant cycle in which compressed refrigerant is supplied to the heat exchanger to be cooled by cold heat from the refrigerant itself, expanded, and supplied back to the heat exchanger has problems in that a large amount of nitrogen refrigerant is required to cool the boil-off gas to a liquefaction temperature due to a difference in heat capacity between nitrogen and the boil-off gas, which contains methane as a main component, and most cold heat in the refrigerant cycle is consumed to cool the nitrogen refrigerant, resulting in increase in capacity of a device for compressing the refrigerant and a device for expanding the refrigerant and increase in power consumption caused thereby. In order to solve these problems, in this embodiment, extremely cold, uncompressed boil-off gas generated from the storage tank is also introduced into the compressor through the heat exchanger to reduce the quantity of refrigerant required for the refrigerant cycle, the capacity of devices for compressing and expanding the refrigerant, and power consumption of the devices, thereby reducing installation and operation costs.

A process of treating boil-off gas generated from liquefied gas in the storage tank in the system according to this embodiment will be described. First, boil-off gas generated in the storage tank T is introduced into the compressor 100a or 100b through the heat exchanger 200.

The compressor 100a or 100b compresses the boil-off gas. For example, the compressor 100a or 100b may compress the boil-off gas to a fuel supply pressure required for an engine of the ship. In particular, for a ship including a propulsion engine and a power generation engine with a lower fuel supply pressure than the propulsion engine while using cold heat from the refrigerant circulated along the refrigerant circulation line for heat exchange in the heat exchanger as in this embodiment, the compressor may compress the boil-off gas to a fuel supply pressure required for the power generation engine E2 to supply the compressed boil-off gas as fuel to the power generation engine E2, and boil-off gas remaining after fueling the power generation engine may be reliquefied. For example, when the power generation engine E2 is a DF GE engine, the compressor may compress the boil-off gas to a pressure of 5 bara to 10 bara.

Classification societies require that a compressor supplying fuel to an engine be designed with redundancy in case of emergency. Here, redundancy is a system design in which a component is duplicated such that, if one thereof is unavailable due to breakdown, maintenance, or the like, the other serves as a backup. To this end, the compressor includes a main compressor 100a and a redundant compressor 100b. In normal operation, one of the two compressors, that is, the main compressor, may be operated to supply fuel to the power generation engine and compressed gas remaining after fueling may be reliquefied through the reliquefaction line RL.

In order to supply fuel to the propulsion engine, the boil-off gas treatment system according to this embodiment may include: a liquefied gas supply line; a compression pump 600 disposed on the liquefied gas supply line, pumping liquefied gas from the storage tank, and pressurizing the liquefied gas to a fuel supply pressure required for the propulsion engine; and a vaporizer 610 disposed on the liquefied gas supply line and heating the pressurized liquefied gas to a fuel supply temperature required for the propulsion engine. In order to supply fuel to the power generation engine, the boil-off gas treatment system according to this embodiment may include: a liquefied gas branch line LL2 branched off the liquefied gas supply line downstream of the vaporizer and connected to the power generation engine E2; a pressure regulating valve 620 provided to the liquefied gas branch line and adjusting the liquefied gas to a fuel supply pressure required for the power generation engine; and a heater 630 provided to the liquefied gas branch line and further heating the liquefied gas having passed through the pressure regulating valve to a fuel supply temperature required for the power generation engine.

The boil-off gas compressed by the compressor is introduced into the heat exchanger 200 along the reliquefaction line RL to be cooled. The compressed boil-off gas to be reliquefied and the refrigerant compressed by the refrigerant compression unit are introduced as a hot stream into the heat exchanger, and the uncompressed boil-off gas and the refrigerant expanded and cooled by the refrigerant expansion unit are introduced as a cold stream into the heat exchanger.

As described above, four streams participate in heat exchange in the heat exchanger 200, wherein a hot stream is cooled through heat exchange with a cold stream. The heat exchanger may be, for example, a brazed aluminum heat exchanger (BAHE).

In order to achieve cooling of the compressed gas to be reliquefied through more effective heat exchange between hot and cold streams, each stream may be introduced into and discharged from the heat exchanger through a different portion of the heat exchanger.

Among the cold streams introduced into the heat exchanger, nitrogen refrigerant introduced into the heat exchanger after being expanded and cooled has a temperature of about −167° C. when the pressure thereof is, for example, about 10 bar, which is lower than the temperature (about −50° C.) of the uncompressed boil-off gas, which is the other cold stream introduced into the heat exchanger. Accordingly, if the nitrogen refrigerant and the uncompressed boil-off gas are introduced together into the heat exchanger, some of the cold heat from the nitrogen refrigerant can be absorbed by streams other than the compressed gas to be re-liquefied, rather than all of the cold heat being used to cool the compressed gas. Accordingly, among the cold streams, the stream of the nitrogen refrigerant (NL) having a relatively low temperature is introduced into a downstream-most section of the heat exchanger to pass through the entirety of the heat exchanger, and the stream of the uncompressed boil-off gas (GL) having a relatively high temperature is introduced into a middle section of the heat exchanger.

Accordingly, the compressed gas from the reliquefaction line is sequentially cooled while passing through the heat exchanger, from a high temperature region to a low temperature region. Specifically, the compressed gas is cooled in the high temperature region through heat exchange with two cold streams, that is, the refrigerant from the refrigerant circulation line and the uncompressed boil-off gas from the boil-off gas supply line, and is then cooled in the low temperature region through heat exchange with one cold stream, that is, the refrigerant from the refrigerant circulation line right after the refrigerant is introduced into the heat exchanger.

In this way, the compressed gas to be re-liquefied can be cooled more effectively, thereby ensuring an increased reliquefaction rate while preventing damage to the related devices through prevention of thermal fatigue of the heat exchanger.

The boil-off gas cooled through heat exchange in the heat exchanger is introduced into a decompressor 400 disposed on the reliquefaction line to be decompressed. The boil-off gas decompressed by the decompressor 400 is introduced into a gas-liquid separator 500.

The decompressor 400 may include an expander adapted to decompress the compressed and cooled boil-off gas or an expansion valve such as a Joule-Thomson valve. When subjected to decompression, the boil-off gas is cooled through adiabatic expansion or isentropic expansion.

The boil-off gas decompressed and further cooled by the decompressor is introduced into the gas-liquid separator 500. A liquid separated by the gas-liquid separator 500 is delivered to the storage tank T along the reliquefaction line RL to be stored in the storage tank T. However, in this embodiment, since complete phase separation of the boil-off gas into a gas (flash gas) and a liquid (liquefied gas) may not be achieved even after the boil-off gas passes through the gas-liquid separator, the separated liquid or liquefied gas may contain unseparated flash gas.

The flash gas separated by the gas-liquid separator may be discharged through an upper portion of the gas-liquid separator to be joined with the stream of the uncompressed boil-off gas upstream of the heat exchanger and a heater and to be introduced into the compressor through the heat exchanger or the heater.

The boil-off treatment system according to this embodiment can reduce CAPEX and OPEX by improving cooling efficiency of the heat exchanger using cold heat from boil-off gas itself and cold heat in the refrigerant cycle and thus eliminating the need to install and operate additional equipment for compressing boil-off gas to a high pressure, such as a boost compressor, to increase a reliquefaction rate of the boil-off gas.

Boil-off gas generated in the storage tank T is discharged from the storage tank at a cryogenic temperature in the range of −140° C. to −100° C. depending on the operation condition of the storage tank. Depending on the type of compressor provided to supply fuel to an engine, boil-off gas introduced into the compressor may be required to be within a certain temperature range. In particular, the compressor for supplying fuel to an engine may be provided as a room-temperature compressor. In this case, when a reliquefaction system is operated at a load higher than a certain range as there is a large amount of boil-off gas to be reliquefied, the cold boil-off gas from the storage tank can be sufficiently heated through heat exchange in the heat exchanger before being introduced into the compressor, whereas, when the reliquefaction system is not in operation or is operated at a low load as the amount of boil-off gas consumed by an engine is large, the cold boil-off gas from the storage tank cannot be heated to a suitable input temperature required for the compressor even after the boil-off gas passes through the heat exchanger.

In order to solve this problem, the boil-off treatment system according to this embodiment includes: a branch line BL allowing boil-off gas from the storage tank T to bypass the heat exchanger 200 to be introduced directly into the compressor 100a or 100b; and a preheater 700 provided to the branch line to heat the boil-off gas.

When the reliquefaction system is in operation, the boil-off gas from the storage tank T may be heated through heat exchange in the heat exchanger 200 before being introduced into the compressor 100a or 100b, whereas, when the reliquefaction system is not in operation or is operated at a low load, all or some of the boil-off gas from the storage tank may bypass the heat exchanger along the branch line BL to be heated by the preheater 700 before being introduced into the compressor 100a or 100b.

As such, in this embodiment, boil-off gas is compressed by the low-pressure compressor and is then supplied as fuel to the power generation engine, surplus compressed gas is reliquefied, and liquefied gas in the storage tank is compressed by the pump and is then supplied as fuel to the propulsion engine through the vaporizer. However, according to this embodiment, since the propulsion engine is not fueled by boil-off gas even when the ship operates at high speed and fuel consumption of the engine is thus high, among the boil-off gas compressed by the compressor, boil-off gas remaining after fueling the power generation engine is required to be reliquefied and the reliquefied liquefied gas is required to be compressed and vaporized again through the compression pump 600 and the vaporizer 610 before being supplied as fuel to the propulsion engine, resulting in low energy efficiency. An expanded embodiment described below is designed to increase energy efficiency by addressing this problem.

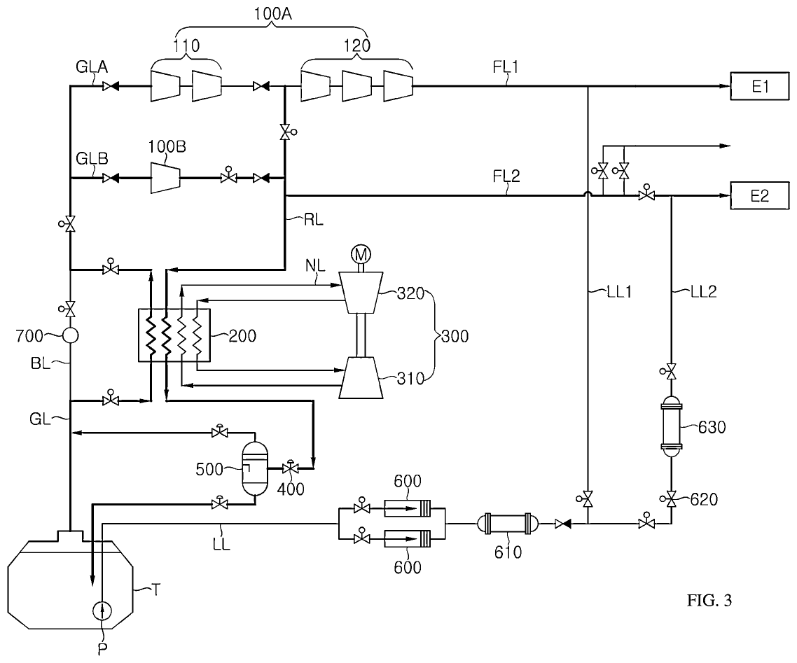

FIG. 3 is a schematic diagram of a boil-off gas treatment system according to an expanded embodiment of the present invention. The following description will focus on differences from the basic embodiment.

The boil-off gas treatment system according to this embodiment differs from the boil-off gas treatment system according to the basic embodiment in terms of the configuration of a compressor that compresses boil-off gas. In this embodiment, a first compressor 100A is configured as a multistage compressor including a plurality of compressors and compressing boil-off gas to a fuel supply pressure required for an onboard propulsion engine E1, and a second compressor 100B is configured as a compressor compressing boil-off gas to a fuel supply pressure required for a power generation engine E2, which is supplied with fuel at a lower pressure than the propulsion engine, such that the second compressor redundant to the first compressor compresses boil-off gas to a different pressure than the first compressor.

Thus, in this embodiment, the first compressor 100A may compress boil-off gas generated in the storage tank to a fuel supply pressure required for the propulsion engine E1 through the plurality of compressors and an intermediate cooler and supply the compressed boil-off gas as fuel to the propulsion engine E1. The power generation engine E2 may be supplied with boil-off gas compressed while passing through part of the first compressor or boil-off gas compressed by the second compressor. In addition, the boil-off gas compressed while passing through part of the first compressor may be supplied to a heat exchanger to be cooled.

To this end, the boil-off gas treatment system according to this embodiment includes: a boil-off gas supply line GL along which boil-off gas is supplied from a storage tank T to the first compressor 100A or the second compressor 100B through a heat exchanger 200; and a first fuel supply line FL1 disposed downstream of the first compressor 100A and connected to the propulsion engine E1.

In addition, the boil-off gas treatment system according to this embodiment includes: a reliquefaction line RL along which boil-off gas compressed while passing through part of the first compressor or through the second compressor is supplied to the heat exchanger 200 to be cooled and is then returned to the storage tank; and a second fuel supply line FL2 along which boil-off gas compressed while passing through part of the first compressor or through the second compressor is supplied to the power generation engine E2. The first compressor 100A includes: a front compression section 110 disposed upstream of a junction between the reliquefaction line and the second fuel supply line along which the boil-off gas compressed while passing through part of the first compressor is supplied to the heat exchanger or the power generation engine; and a rear compression section 120 further compressing boil-off gas compressed in the front compression section to a fuel supply pressure required for the propulsion engine. For example, when the propulsion engine is an ME-GI engine and the power generation engine is a DFGE engine, the front compression section of the first compressor may compress boil-off gas to a pressure of 5 bara to 12 bara and the rear compression section of the first compressor may compress boil-off gas to a pressure of 250 bara to 400 bara.

In the system according to this embodiment, either the first compressor or the second compressor may be selectively operated depending on the operation condition of the ship.

When the engines of the ship consume a large amount of fuel, such as when the ship is underway, the first compressor 100A is operated. Boil-off gas generated in the storage tank T is supplied to the heat exchanger 200 along the boil-off gas supply line GL and is then sent to the first compressor 100A along a first line GLA to be compressed. Here, boil-off gas compressed while passing through the entirety of the first compressor 100A is supplied as fuel to the propulsion engine E1 along the first fuel supply line FL1, and boil-off gas compressed while passing through the front compression section 110 of the first compressor is supplied as fuel to the power generation engine E2 along the second fuel supply line FL2. Surplus compressed gas in excess of what is needed for the propulsion engine and the power generation engine is supplied to the heat exchanger 200 along the reliquefaction line RL, cooled through heat exchange with a refrigerant circulated along a refrigerant circulation line NL and uncompressed boil-off gas, reliquefied through a decompressor 400 and a gas-liquid separator 500, and returned to the storage tank T. When there is no surplus compressed gas to be reliquefied after fueling the engines, the reliquefaction system may not be operated, or boil-off gas in the storage tank may be supplied directly to the first compressor along a branch line BL without passing through the heat exchanger.

When the propulsion engine E1 consumes little or no fuel, such as when the ship is at anchor, the second compressor 100B is operated. Here, boil-off gas generated in the storage tank is sent to the second compressor 100B through the heat exchanger 200 to be compressed and is then supplied as fuel to the power generation engine E2. Surplus compressed gas in excess of what is needed for the power generation engine E2 is supplied to the heat exchanger 200 along the reliquefaction line RL to be cooled, reliquefied through the decompressor 400 and the gas-liquid separator 500, and returned to the storage tank T.

As such, in this embodiment, as a multistage high-pressure compressor capable of supplying boil-off gas as fuel to a propulsion engine and a compressor capable of compressing boil-off gas to a pressure required for a power generation engine having a lower fuel supply pressure than the propulsion engine are provided to be selectively operated depending on the operation condition of a ship, consumption of electrical energy required for fuel supply and reliquefaction can be reduced through utilization of boil-off gas as fuel while meeting redundancy requirements, thereby ensuring efficient operation of the ship.

In addition, since the cooling efficiency and reliquefaction rate of the heat exchanger can be enhanced through utilization of cold heat from boil-off gas itself and cold heat in the refrigerant cycle and reliquefaction can be performed with respect to only boil-off gas remaining after boil-off gas generated in the storage tank is consumed as fuel, the load of the refrigerant cycle can be reduced while reducing consumption of liquefied gas as fuel.

Although some embodiments have been described, it will be apparent to those skilled in the art that these embodiments are given by way of illustration only, and that various modifications, changes, alterations, and equivalent embodiments can be made without departing from the spirit and scope of the invention.

1. A boil-off gas treatment system of a ship, comprising:
a first compressor receiving boil-off gas generated from liquefied gas stored in a storage tank of the ship and compressing the received boil-off gas;
a second compressor compressing boil-off gas received from the storage tank;
a heat exchanger cooling the boil-off gas compressed by the first compressor or the second compressor; and
a refrigerant circulation line along which a refrigerant supplied to the heat exchanger is circulated,
wherein the first compressor is a multistage compressor comprising a plurality of compressors and compressing the boil-off gas to a fuel supply pressure required for a propulsion engine of the ship,
the second compressor compresses the boil-off gas to a fuel supply pressure required for a power generation engine supplied with fuel at a lower pressure than the propulsion engine, and
boil-off gas compressed while passing through part of the first compressor is supplied to the heat exchanger to be cooled or is supplied to the power generation engine.

2. The boil-off gas treatment system according to claim 1, wherein the refrigerant circulation line comprises:
a refrigerant compression unit receiving the refrigerant discharged from the heat exchanger after heat exchange and compressing the received refrigerant; and
a refrigerant expansion unit receiving the refrigerant compressed by the refrigerant compression unit and having passed through the heat exchanger, expanding and cooling the received refrigerant, and supplying the cooled refrigerant to the heat exchanger.

3. The boil-off gas treatment system according to claim 1, further comprising:
a boil-off gas supply line along which boil-off gas is supplied from the storage tank to the first compressor or the second compressor through the heat exchanger;
a first fuel supply line disposed downstream of the first compressor and connected to the propulsion engine;
a reliquefaction line along which boil-off gas compressed while passing through part of the first compressor or through the second compressor is supplied to the heat exchanger to be cooled and is returned to the storage tank; and
a second fuel supply line along which boil-off gas compressed while passing through part of the first compressor or through the second compressor is supplied to the power generation engine.

4. The boil-off gas treatment system according to claim 3, further comprising:
a branch line branched off of the boil-off gas supply line and allowing boil-off gas to be supplied to the first compressor or the second compressor without passing through the heat exchanger; and
a preheater provided to the branch line to heat the boil-off gas,
wherein, when a reliquefaction system is not in operation or is operated at a low load, all or some of the boil-off gas generated in the storage tank bypasses the heat exchanger along the branch line to be heated by the preheater and is introduced into the first compressor or the second compressor.

5. The boil-off gas treatment system according to claim 4, further comprising:
a decompressor receiving compressed boil-off gas cooled through heat exchange in the heat exchanger and decompressing the received compressed boil-off gas; and
a gas-liquid separator receiving the boil-off gas decompressed by the decompressor and performing gas-liquid separation with respect to the received boil-off gas,
wherein flash gas separated by the gas-liquid separator is joined with a stream of uncompressed boil-off gas upstream of the heat exchanger, and liquefied gas separated by the gas-liquid separator is returned to the storage tank.

6. The boil-off gas treatment system according to claim 5, further comprising:
a liquefied gas supply line along which liquefied gas stored in the storage tank is supplied as fuel to the propulsion engine;
a compression pump disposed on the liquefied gas supply line and pressurizing the liquefied gas to a fuel supply pressure required for the propulsion engine; and
a vaporizer heating the liquefied gas pressurized by the compression pump.

7. The boil-off gas treatment system according to claim 6, further comprising:
a liquefied gas branch line branched off of the liquefied gas supply line downstream of the vaporizer and connected to the power generation engine;
a pressure regulating valve provided to the liquefied gas branch line and adjusting the liquefied gas to a fuel supply pressure required for the power generation engine; and
a heater provided to the liquefied gas branch line and further heating the liquefied gas having passed through the pressure regulating valve to a fuel supply temperature required for the power generation engine.

8. The boil-off gas treatment system according to claim 1, wherein, when the ship is underway, the first compressor is operated to compress boil-off gas generated in the storage tank and supply the compressed boil-off gas to the propulsion engine and the power generation engine and surplus compressed gas is cooled by the heat exchanger, and
when the ship is at anchor, the second compressor is operated to compress boil-off gas generated in the storage tank and to supply the compressed boil-off gas to the power generation engine and surplus compressed gas is cooled by the heat exchanger.

9. The boil-off gas treatment system according to claim 8, wherein the refrigerant circulated along the refrigerant circulation line is nitrogen.

10. A boil-off gas treatment method of a ship including a propulsion engine and a power generation engine supplied with fuel at a lower pressure than the propulsion engine,
wherein boil-off gas generated from liquefied gas stored in a storage tank is compressed by a first compressor or a second compressor, compressed gas not supplied as fuel to the propulsion engine and the power generation engine is cooled and reliquefied through heat exchange in a heat exchanger supplied with a refrigerant circulated along a refrigerant circulation line,
the first compressor is a multistage compressor comprising a plurality of compressors and compressing the boil-off gas to a fuel supply pressure required for the propulsion engine, the second compressor compresses the boil-off gas to a fuel supply pressure required for the power generation engine, and
boil-off gas compressed while passing through part of the first compressor is supplied to the heat exchanger to be cooled or is supplied to the power generation engine.

11. The boil-off gas treatment method according to claim 10,
wherein, when the ship is underway, the first compressor is operated to compress boil-off gas generated in the storage tank and supply the compressed boil-off gas to the propulsion engine and the power generation engine and surplus compressed gas is cooled by the heat exchanger, and
when the ship is at anchor, the second compressor is operated to compress boil-off gas generated in the storage tank and to supply the compressed boil-off gas to the power generation engine and surplus compressed gas is cooled by the heat exchanger.

12. The boil-off gas treatment method according to claim 11,
wherein the refrigerant circulated along the refrigerant circulation line is compressed by a refrigerant compression unit, cooled through the heat exchanger, expanded and cooled by a refrigerant expansion unit, and supplied to the heat exchanger as a cold heat source, and
the refrigerant compression unit being connected to the refrigerant expansion unit to compress the refrigerant using expansion energy of the refrigerant transmitted from the refrigerant expansion unit.
